(19) United States
(12) Patent Application Publication
(10) Pub. No.: US 2005/0105060 A1
(43) Pub. Date: May 19, 2005

(54) Projecting apparatus and method of projection

(76) Inventor: Tomoyuki Miura, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/948,573

(22) Filed: Sep. 24, 2004

(30) Foreign Application Priority Data
Nov. 17, 2003 (JP) 2003-357865

(51) Int. Cl. G03B 21/20

(52) U.S. Cl. 353/85

(57) ABSTRACT

The present invention provides a projecting apparatus including a driving portion which receives a predetermined signal to output a driving signal, a separating portion which separates a video signal into a horizontal synchronous signal and a vertical synchronous signal, a color correcting portion which adds a color correction to the horizontal synchronous signal and vertical synchronous signal to generate and output a color correction signal, multiple projection cathode ray tubes which receive the driving signal and the color correction signal to emit a light which is projected in accordance with the driving signal and which is subjected to the color correction by the color correction signal, and a display portion which receives the projected light to display a video. This configuration corrects the unevenness of colors from the multiple projection cathode ray tubes.

### CROSS-REFERENCE TO RELATED APPLICATIONS

This application is based upon and claims the benefit of priority from prior Japanese Patent Application No. 2003-357865, filed Oct. 17, 2003, the entire contents of which are incorporated herein by reference.

### BACKGROUND OF THE INVENTION

1. Field of the Invention

The present invention relates to a projecting apparatus using a projection lamp, and in particular, to a projecting apparatus and a method of projection in which loads on a projection lamp are estimated in accordance with the level of an output coefficient to accurately predict the lifetime of the lamp.

2. Description of the Related Art

A large number of digital video apparatus have recently been popularized. These digital video apparatuses include, for example, projection apparatuses such as liquid crystal projectors and DLP projectors which employ a light source lamp. The light source lamp utilized in such a liquid crystal projector has a lifetime indicated by an integrated usage time indicating the time for which the lamp remains available. Light source lamps the integrated usage time of which is close to or exceeds the lamp lifetime may have their characteristics degraded or may become defective and unavailable. These lamps are thus unreliable.

As a conventional technique (Jpn. Pat. Appln. KOKAI Publication No. 2002-287243) for such an optical disk apparatus, a projector apparatus has been disclosed which automatically estimates the integrated usage time for the light source lamp and which urges, on a screen, a user to change the lamp in accordance with the lifetime of the lamp. Thus, the user can determine the lamp lifetime at an optimum time to change the lamp. Accordingly, the capabilities of the lamp can be fully provided.

This conventional technique recognizes that a variation in projection angle may result in uneven colors, which should be electrically resolved. However, it does not specifically disclose what circuit should be used or how a correction signal should be generated. Thus, this invention clarifies the object but fails to disclose a technique sufficient to allow those skilled in the art to achieve the object.

That is, the light source lamp of the projector apparatus shown in the above conventional technique has a function to switch the quantity of light as required. In this connection, it is known that loads on the lamp depend on the quantity of light. Accordingly, if a 100% quantity of light is not always projected but a different quantity of light, for example, a 50% quantity of light is used, the method according to the conventional technique cannot obtain the accurate estimated amount of loads on the light source lamp. Thus, disadvantageously, the apparatus may urge the lamp light source to be changed even though it is not fully exhausted.

### BRIEF SUMMARY OF THE INVENTION

An embodiment according to the present invention is a projecting apparatus characterized by comprising a driving portion which outputs a driving current in association with a control signal containing an output coefficient, a lamp portion which receives the driving current from the driving portion to project light, and a control portion which supplies the driving portion with a control signal containing the output coefficient and which estimates loads on the lamp portion in accordance with the output coefficient and an operation time of the control signal.

### BRIEF DESCRIPTION OF THE SEVERAL VIEWS OF THE DRAWING

FIG. 1 is a block diagram showing an example of the configuration of a projecting apparatus according to the present invention;

FIGS. 2A and 2B are schematic views showing an example of the appearance of the projecting apparatus according to the present invention;

FIG. 3 is a view illustrating an example of an optical configuration of the projecting apparatus according to the present invention;

FIG. 4 is a flow chart showing an example of a process of estimating the lifetime of a lamp in the projecting apparatus according to the present invention;

FIGS. 5A and 5B are views illustrating an example of display provided by the projecting apparatus according to the present invention; and

FIG. 6 is a timing chart showing an example of a grid signal from a blue projection cathode ray tube according to the present invention.

### DETAILED DESCRIPTION OF THE INVENTION

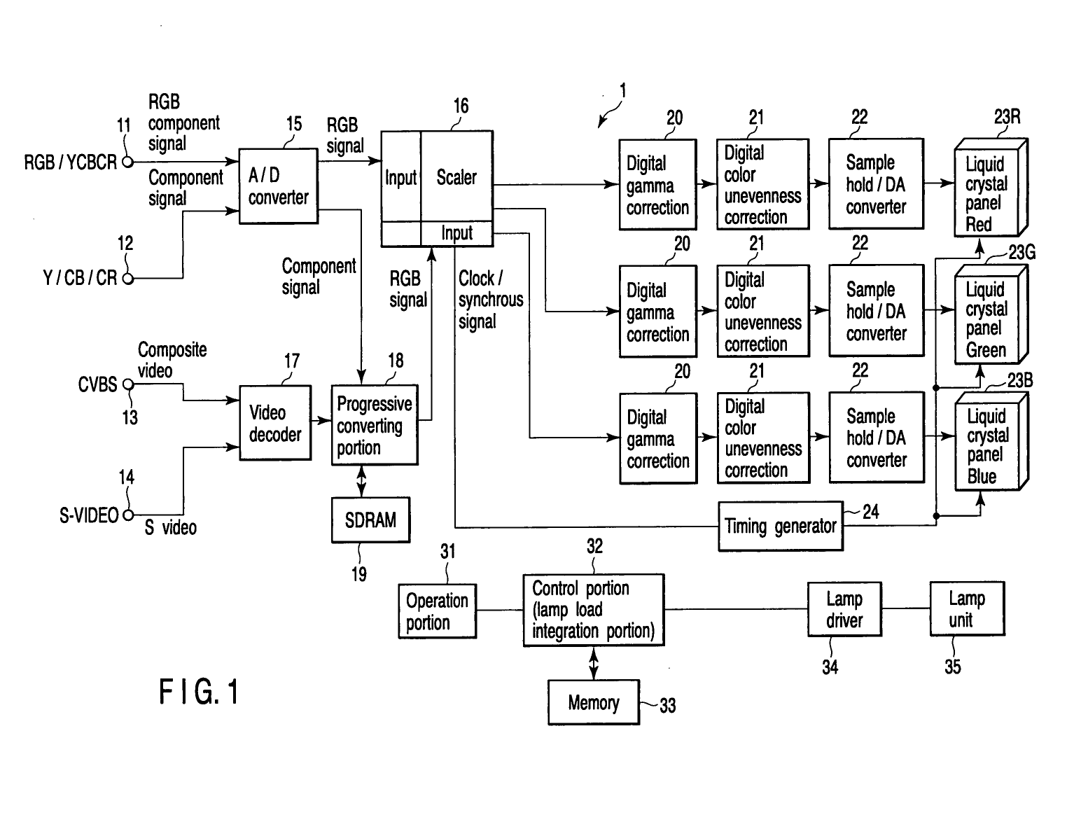

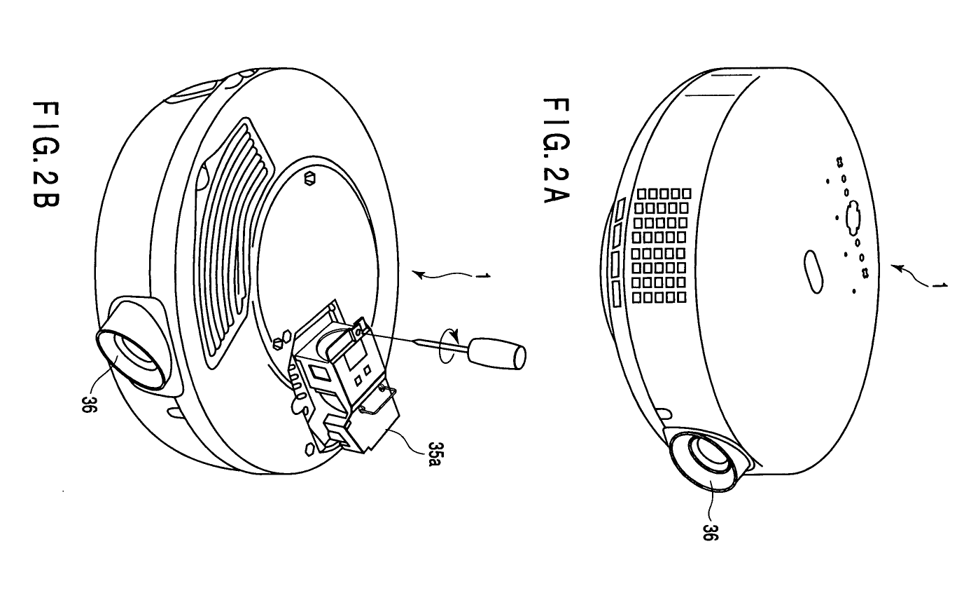

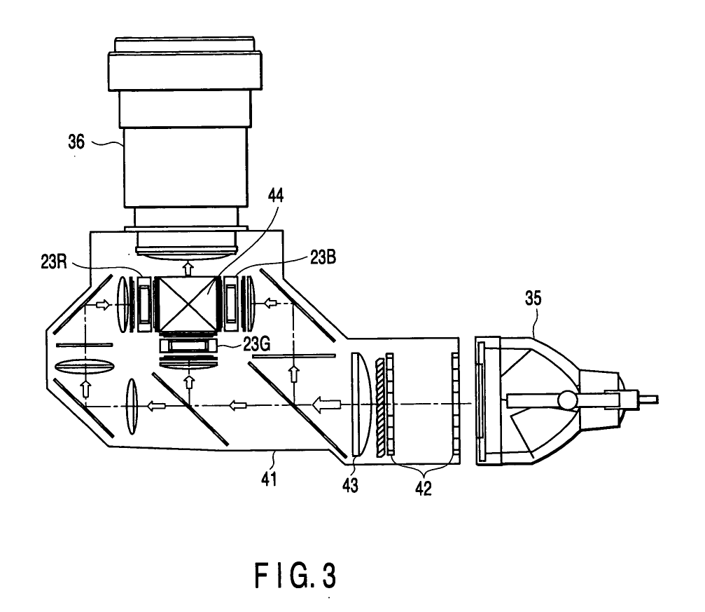

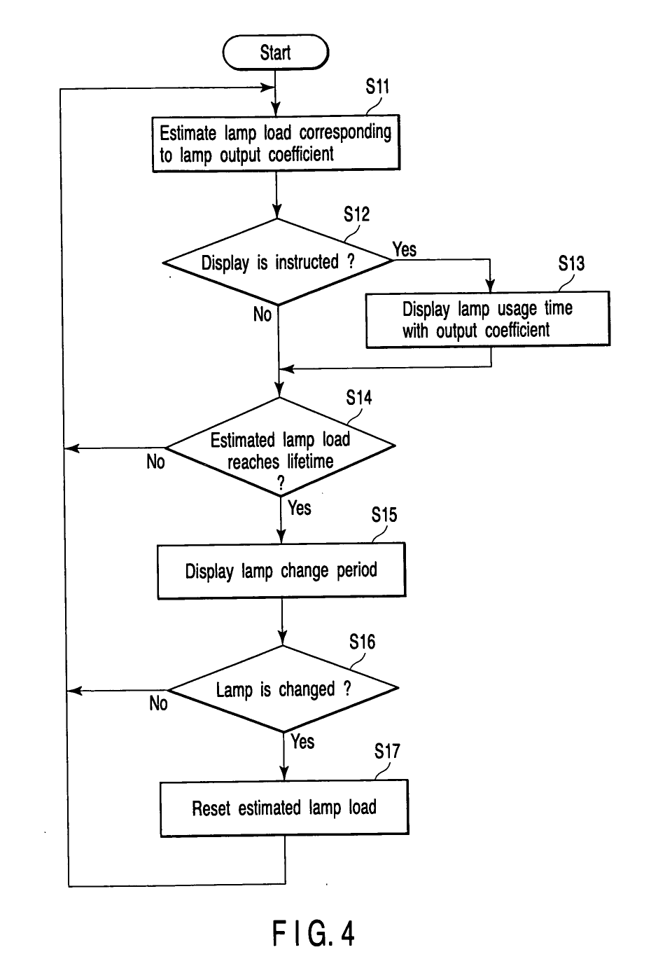

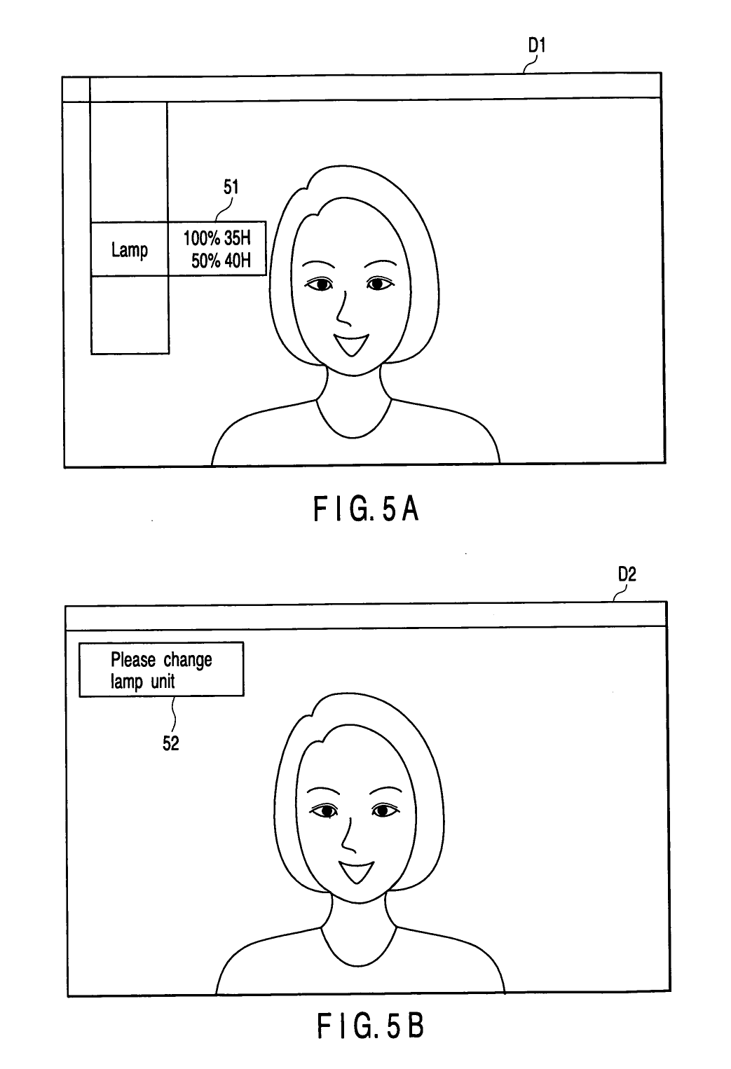

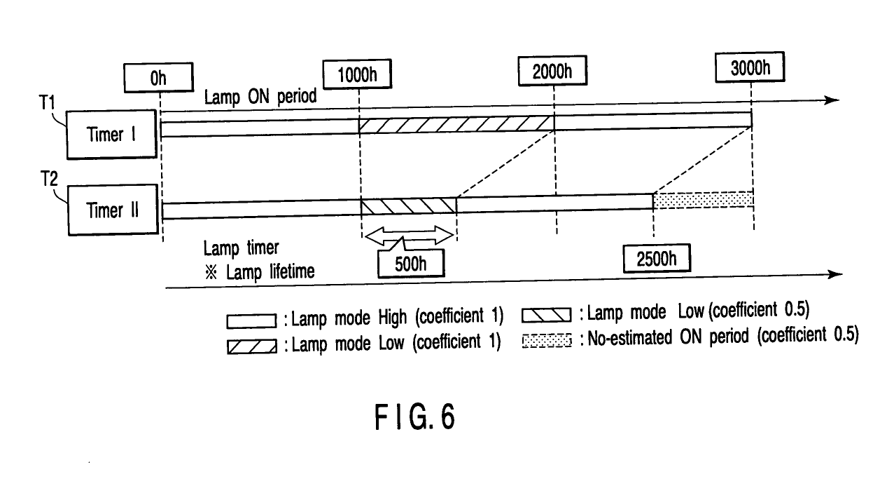

With reference to the drawings, a detailed description will be given of an embodiment of a projecting apparatus according to the present invention. The projecting apparatus according to the present invention determines the lifetime of the light source lamp on the basis of the time for which the light source lamp has been used as well as an output coefficient for the light source lamp. FIG. 1 is a block diagram showing an example of the configuration of the projecting apparatus according to the present invention. FIGS. 2A and 2B are schematic views showing an example of the appearance of the projecting apparatus according to the present invention. FIG. 3 is a view illustrating an example of an optical configuration of the projecting apparatus according to the present invention. FIG. 4 is a flow chart showing an example of a process of estimating the lifetime of the lamp in the projecting apparatus according to the present invention. FIGS. 5A and 5B are views illustrating an example of display provided by the projecting apparatus according to the present invention. FIG. 6 is a timing chart showing an example of a grid signal from a blue projection cathode ray tube according to the present invention.

Projecting Apparatus according to Present Invention

(Construction)

A projecting apparatus 1 according to the present invention has an RGB component terminal 11, a Y/CB/CR terminal 12, an A/D converter 15 that receives these terminals, a scaler 16 that receives an output from the A/D converter 15, a CVBS terminal 13, an S-VIDEO terminal 14, a video decoder 17 that receives outputs from these terminals, a progressive converting portion 18 that receives an output from the video decoder 17, and an SDRAM 19 connected to the progressive converting portion 18. Further, a component signal from the A/D converter 15 is supplied to the progressive converting portion 18. An RGB signal from the progressive converting portion 18 is supplied to the scaler 16.

Furthermore, outputs from the scaler 16 which correspond to an R signal, a G signal, and a B signal, respectively, are supplied to respective digital gamma correction portions 20. Outputs from the digital gamma correction portions 20 are supplied to respective sample hold/DA converters 22. Outputs from the sample hold/DA converters 22 are provided to liquid crystal panels 23R, 23G, and 23B.

Further, an output from the scaler 16 is supplied to a timing generator 24. The timing generator 24 supplies synchronous signals to the liquid crystal panels 23R, 23G, and 23B.

The projecting apparatus 1 has a control section 32 that controls the above operations. The control section 32 has a function of a lamp load integration portion, described later, to estimate loads on a lamp. The control section 32 has a memory and supplies a control signal to a lamp driver 34. The lamp driver 34 supplies a projection lamp 35 with a driving current with an output coefficient.

The projecting apparatus 1 has an appearance such as the one shown in FIGS. 2A and 2B. The front view in FIG. 2A shows a projection lens 36. The rear view in FIG. 2B shows a projection lamp unit 35a to be changed.

The projection lamp unit 35a of the projecting apparatus 1 has the projection lamp 35 inside, which is shown by the optical configuration in FIG. 3. The projection lamp 35 is placed near an optical unit 41. Light emitted by the optical unit 41 passes through a multilens 42 and a convex lens 43 provided adjacent to the multilens 42. The light then passes through or is reflected by a transmission mirror and is then transmitted through the liquid crystal panels 23R, 23G, and 23B. Thus, the light emitted by the projection lamp 35 and containing a video is applied through the projection lens 36. Consequently, a video image is formed on a screen or the like (not shown) on which the light is projected.

(Operations)

Now, operations of the projecting apparatus 1 will be described in detail with reference to the drawings. A video signal is supplied to the RGB component terminal 11, the Y/CB/CR terminal 12, the CVBS terminal 13, or the S-VIDEO terminal 14. Then, one input is selected under the control of the control portion 32. If a component signal is inputted via the RGB component terminal 11 or the Y/CB/CR terminal 12, the A/D converter 15 converts it into a digital signal. If a signal is inputted through the CVBS terminal 13 or the S-VIDEO terminal 14, the video decoder 17 decodes it. Then, the progressive converting portion 18 converts the decoded signal into an RGB signal and outputs the RGB signal to the scaler 16. The scaler 16 converts the RGB signal in accordance with the size of each of the liquid crystal panels 23R, 23G, and 23B. The scaler 16 then supplies the converted signal to the digital gamma correction portion 20 for the respective color signals. The digital gamma correction section 20 executes gamma corrections to adjust the linearity of the video information to obtain video signals and then supplies the signals to the respective digital color unevenness correction portion 21. The video signals subjected to color unevenness corrections are supplied to the sample hold/DA converter 22. The sample hold/DA converters 22 subject the video signals to DV conversions and supplies the converted signals to the liquid crystal panels 23R, 23G, and 23B, respectively. In accordance with synchronous signals from the timing generator 24, the liquid crystal panels 23R, 23G, and 23B display videos corresponding to the video information, on respective liquid crystal screens.

On the other hand, upon receiving an operation signal from an operation portion 31, the control portion 32 supplies a control signal to the lamp driver 34 in order to provide a lamp output with an output coefficient of 1 (100%). Then, the projection lamp 35 projects light in response to a driving signal from the lamp driver 34.

Subsequently, the videos for the respective color signals are displayed on the liquid crystal screens as follows: as shown in FIG. 3, light from the projection lamp 35 is projected into an optical unit 41, passes through the multilens 42 and the convex lens 43, then passes through or is reflected by the transmission mirror, and is subsequently applied to the liquid crystal panels 23R, 23G, and 23B as projected light. Then, the projected light with the video is applied through the projection lens 36 to form and display the video on the screen or the like (not shown).

(Lamp Load Integration Process)

Now, with reference to the flow chart shown in FIG. 4, an example of display shown in FIGS. 5A and 5B and provided by the projecting apparatus, and the timing chart in FIG. 6, a detailed description will be given of a process of estimating loads on the lamp in the projecting apparatus, which process is a characteristic of the present invention. The projecting apparatus 1 according to the present invention determines the lifetime of the projection lamp 3 in accordance with the output coefficient of the projection lamp 3. Specifically, the projection lamp 35 may not only provide a 100% output but also apply a suppressed output, for example, a 50% or 75% output. This saves power and serves to prolong the lifetime of the lamp. In this case, High (a 100% output) and Low (a 50% output) will be described by way of example.

In this case, as shown in the timing chart in FIG. 6, for a timing T1 for a timer 1, which corresponds to a process of estimating loads on the lamp which process does not take the output coefficient of the projection lamp into account, if High lasts 1,000 hours, Low lasts 1,000 hours, and then High lasts 1,000 hours, all estimations are carried out using a coefficient of 1 to determine that a total of 3,000 H of lifetime has been spent. Even in this case, for a timing T2 for a timer 2, which corresponds to a process of estimating loads on the lamp which process is executed by the control portion 32 of the projecting apparatus 1 according to the present invention taking the output coefficient of the projection lamp into account, integrated loads on the lamp portion are measured using a coefficient of 0.5 for the 1,000 hours of Low. Thus, the control section 32 recognizes a total of 2,500 hours of integrated loads on the projection lamp. Consequently, the control section 32 can measure a value for the loads actually imposed on the lamp portion to accurately determine the lifetime of the lamp portion.

Specifically, in the flow chart shown in FIG. 4, when the projecting apparatus 1 is activated in response to an operation of the operation portion 31, the control portion 32 estimates loads on the lamp in accordance with the output coefficient of the lamp (S11). Specifically, the usage time of the lamp portion is estimated as a lamp load using a coefficient of 1 for High (a 100% output) and a coefficient of 0.5 for Low (a 50% output). This makes it possible to accurately determine integrated loads on the projection lamp as shown in connection with the timing T2 for the timer 2 in the timing chart of FIG. 6. Then, an estimating process is executed using, for example, a coefficient of 0.75 for a 75% output or a coefficient of 0.25 for a 25% output.

Then, if an instruction given by a user using the operation portion 31 urges the usage time of the lamp to be displayed, then for example, 35H or 40H is displayed for 100% or 50% usage, respectively, as shown by an icon 51 in FIG. 5A on the basis of the integrated time accumulated in a memory 33. Alternatively and suitably, a 50% output is treated as a time obtained through a multiplication by a coefficient of 0.5 and is displayed as H=35+40×2=55 H.

Then, it is determined whether or not the integrated loads on the lamp portion exhibit a value corresponding to a given lamp lifetime. Suitably, if it is determined that this value has been reached (S14), the control portion 32 then uses an icon to display “Please change lamp unit” or the like as shown in FIG. 5B (S15).

Moreover, a change of the projection lamp 35 is suitably detected by a sensor (not shown) provided in the lamp unit 35a or in the main body of the projecting apparatus 1. Thus, when a change of the lamp is automatically recognized (S16), the integrated lamp load is suitably automatically reset (S17). However, after the lamp has been changed, the user may suitably manually reset the timer via the operation portion 31.

To provide time information on the lamp lifetime, it is possible to provide one value by default or to provide the lamp unit 35a with a sensor to determine the lifetime. Alternatively, the user may provide lifetime information to the memory 33 or the like via the operation portion 31.

Alternatively, the control portion 32 may suitably determine the remaining available time (lifetime) on the basis of the current integrated lamp load and the given lamp lifetime to display an available time for each of multiple output coefficients for the lamp portion, on the screen of the display portion. Specifically, if 1,000 hours remain, the control portion 32 executes calculations to display 1,000 hours for a 100% output or 2,000 hours for a 50% output on the screen. This enables the user to make an intuitive choice.

The above projecting apparatus estimates the loads on the light source lamp on the basis of not only the usage time of the light source lamp but also the output coefficient such as 100% or 50%. Specifically, calculations are executed so that even if the lamp has been used for 10 hours, if the output coefficient is 50%, the loads on the light source lamp are assumed to be integrated only for 5 hours for an output coefficient of 100%. This enables the lifetime of the lamp to be accurately predicted also taking the value of the output coefficient into account. Further, by accurately predicting the set lifetime of the light source lamp, it is possible to examine the usage of the light source lamp for the rest of the lifetime also taking the output coefficient of the lamp into account. Specifically, on the basis of the given lifetime of the light source lamp and the integrated loads on the light source lamp, it is possible to show, for example, that the lamp can be used for five more hours if the output coefficient is 100% or for ten more hours if the output coefficient is 50%.

Those skilled in the art can implement the present invention on the basis of the various embodiments described above. However, many variations of these embodiments occur easily to those skilled in the art and can be applied as various embodiments without any inventive abilities. Therefore, the present invention covers a wide range consistent with the disclosed principles or novel features. The present invention is thus not limited to the above embodiments.

1. A projecting apparatus comprising:
a driving portion which outputs a driving current in association with a control signal containing an output coefficient;
a lamp portion which receives the driving current from the driving portion to project light; and
a control portion which supplies the driving portion with a control signal containing the output coefficient and which estimates loads on the lamp portion in accordance with the output coefficient and an operation time of the control signal.

2. The projecting apparatus according to claim 1, wherein upon determining that the integrated loads on the lamp portion exhibit a value corresponding to a given lifetime of the lamp portion, the control portion outputs a signal indicating that the value corresponding to the lifetime has been reached.

3. The projecting apparatus according to claim 1, further comprising:
a display portion which provides a display on a screen in accordance with video information and which receives projected light from the lamp portion on the screen to emit projected light containing a video corresponding to the video information,
wherein upon determining that the integrated loads on the lamp portion exhibit a value corresponding to a given lifetime of the lamp portion, the control portion shows, on the screen of the display portion, that the value corresponding to the lifetime has been reached.

4. The projecting apparatus according to claim 1, wherein the display portion has an R liquid crystal panel, a G liquid crystal panel, and a B liquid crystal panel which display respective images corresponding to an R, G, and B video signals into which the video information is separated.

5. The projecting apparatus according to claim 3, wherein upon determining that the integrated loads on the lamp portion exhibit a value corresponding to a given lifetime of the lamp portion, the control portion causes the screen of the display portion to show that the value corresponding to the lifetime has been reached and to urge the lamp portion to be changed.

6. The projecting apparatus according to claim 3, wherein the control portion displays, on the screen of the display portion, a usage time for each output coefficient of the lamp portion.

7. The projecting apparatus according to claim 3, wherein the control portion determines a remaining lifetime on the basis of the lifetime of the lamp portion and the current integrated loads on the lamp portion to display, on the screen of the display portion, an available time for each of a plurality of output coefficients for the lamp portion.

8. The projecting apparatus according to claim 7, wherein the control portion displays the available time for each of the plurality of output coefficients on the screen in response to an instruction from an operation portion.

9. The projecting apparatus according to claim 5, wherein after the screen has urged the lamp portion to be changed, upon detecting a change of the lamp portion, the control portion resets the integrated loads on the lamp portion.

10. The projecting apparatus according to claim 5, wherein after the screen has urged the lamp portion to be changed, upon detecting a change of the lamp portion on the basis of a signal from a sensor in the lamp portion, the control portion resets the integrated loads on the lamp portion.

11. A method of projection comprising:
outputting a control signal containing an output coefficient to a driving portion supplying a driving current to a lamp portion to cause the driving portion to project light; and
estimating loads on the lamp portion on the basis of the output coefficient and an operation time of a control signal.

12. The method of projection according to claim 11, wherein when it is determined that the integrated loads on the lamp portion exhibit a value corresponding to a given lifetime of the lamp portion, a signal is outputted indicating that the value corresponding to the lifetime has been reached.

13. The method of projection according to claim 11, further comprising:
using a display portion which provides a display on a screen in accordance with video information and which receives projected light from the lamp portion on the screen to emit projected light containing a video corresponding to the video information, and upon determining that the integrated loads on the lamp portion exhibit a value corresponding to a given lifetime of the lamp portion, showing, on the screen of the display portion, that the value corresponding to the lifetime has been reached.

14. The method of projection according to claim 13, wherein the display portion has an R liquid crystal panel, a G liquid crystal panel, and a B liquid crystal panel which display respective images corresponding to an R, G, and B video signals into which the video information is separated.

15. The method of projection according to claim 13, wherein when it is determined that the integrated loads on the lamp portion exhibit a value corresponding to a given lifetime of the lamp portion, the screen of the display portion shows that the value corresponding to the lifetime has been reached and urges the lamp portion to be changed.

16. The method of projection according to claim 13, wherein a usage time for each output coefficient of the lamp portion is displayed on the screen of the display portion.

17. The method of projection according to claim 13, further comprising:
determining a remaining lifetime on the basis of the lifetime of the lamp portion and the current integrated loads on the lamp portion to show, on the screen of the display portion, an available time for each of a plurality of output coefficients for the lamp portion.

18. The method of projection according to claim 17, wherein the available time for each of the plurality of output coefficients is displayed on the screen of the display portion in response to an instruction from an operation portion.

19. The method of projection according to claim 15, wherein after the screen has urged the lamp portion to be changed, when a change of the lamp portion is detected, the integrated loads on the lamp portion are reset.

20. The method of projection according to claim 15, wherein after the screen has urged the lamp portion to be changed, when a change of the lamp portion is detected on the basis of a signal from a sensor in the lamp portion, the integrated loads on the lamp portion are reset.
